(19) United States
(12) Patent Application Publication
(10) Pub. No.: US 2019/0011181 A1
(43) Pub. Date: Jan. 10, 2019

(54) DEWATERING APPARATUS

(71) Applicant: ANDREW HUGH BURDEN LIMITED, Ferndown Dorset (GB)

(72) Inventor: Andrew Hugh Burden, Ferndown Dorset (GB)

(73) Assignee: ANDREW HUGH BURDEN LIMITED, Ferndown Dorset (GB)

(21) Appl. No.: 16/060,623

(22) PCT Filed: Dec. 8, 2016
(86) PCT No.: PCT/GB2016/053860

§ 371 Date: Jun. 8, 2018

(30) Foreign Application Priority Data
Dec. 9, 2015 (GB) 1521673.2

(51) Int. Cl. F26B 5/12

(52) U.S. Cl. CPC F26B 5/12

(57) ABSTRACT

A dewatering apparatus (10) for reducing the moisture content of a stockpile of material (40). The apparatus (10) including a support, pressure reducing means in the form of a pump (30) and fluid communication means in the form of a pipe arrangement (16). A layer of impermeable material (34) is provided beneath the support (12), whilst a material which has a higher permeability than the stockpile (40) is provided on the support. A solids filter (62) is provided to remove solid materials from the fluid prior to reaching the pump (30).

The present invention relates to dewatering apparatus, and particularly but not exclusively dewatering apparatus for reducing the moisture content of stockpiles of materials such as aggregates.

Following extraction from the ground, aggregates such as sand and gravel are washed and stored externally in stockpiles to allow the moisture content to reduce naturally through drainage by gravity. However, natural gravity drainage is slow and depends upon weather conditions, the ground on which the stockpile is located, and the permeability of the material in the stockpile. The slowness of reduction of the moisture content means that more stockpile storage must be provided, and in some circumstances, the aggregate has to be pre-dried before use to ensure that the moisture content is satisfactory, thereby increasing costs.

According to a first aspect of the present invention, there is provided dewatering apparatus for reducing the moisture content of a stockpile of material, the apparatus including a support for supporting, in use, the stockpile, pressure reducing means, and fluid communication means for communicating fluid from the support to the pressure reducing means wherein the apparatus includes a substantially impermeable layer beneath the support, and the support includes a layer of material which has a permeability which is higher than the permeability of the stockpile material, a solids filter being provided in the fluid communication means to remove solid materials from the fluid prior to the fluid reaching the pressure reducing means.

The solids filter may comprise a mesh material extendable across the fluid communication means. The mesh material may be extendable across an annular frame. A mounting ring may be mountable to the annular frame to removably clamp the mesh material extending across the annular frame.

According to a second aspect of the present invention, there is provided dewatering apparatus for reducing the moisture content of a stockpile of material, the apparatus including a support for supporting, in use, the stockpile, pressure reducing means, and fluid communication means for communicating fluid from the support to the pressure reducing means wherein the apparatus includes a substantially impermeable layer beneath the support, and the support includes a layer of material which has a permeability which is higher than the permeability of the stockpile material, an air separator being provided in the fluid communication means to remove air from the fluid prior to the fluid reaching the pressure reducing means.

The air separator may include a tank into which the fluid flows, with formations in the tank to stop spinning of the fluid. The formations may be in the form of baffles. An exhaust may be provided in an upper part of the tank to enable air to be exhausted therethrough.

The apparatus may include a solids filter and an air separator. The air separator may be located downstream of the solids filter, and may be located immediately downstream of the solids filter.

Possibly, the pressure reducing means includes a suction pump, which may be a vacuum pump, and may be self priming.

Possibly, in use, the support is located in the ground. The impermeable layer may be located between the support and adjacent material in the ground.

Possibly, the layer of higher permeable material is located in a lowermost part of the support.

Possibly, the fluid communication means defines a passage, and may include a pipe arrangement, which may include a pipe, which may define the passage. Possibly, the pipe includes an inlet part, in which the pipe defines one or more inlet apertures through which fluid enters the passage in use. Possibly, the inlet part is located within the support, and may be located in a lowermost part of the support, and may be located within the layer of higher permeable material. Possibly, the lowermost part of the support is arranged to direct fluid to the inlet part. Possibly, the lowermost part of the support slopes downwardly towards the inlet part.

Possibly, the inlet part is located above the impermeable layer, and may be located on the impermeable layer.

Possibly, the pipe arrangement includes an outer filter, which may be arranged to permit entry of the fluid into the passage, but prevent entry of the support and/or stockpile material into the passage, and may be located between the inlet part and the support.

The outer filter may be in the form of a geotextile.

Possibly, the fluid communication means include a plurality of pipe arrangements. Possibly, the fluid communication means include a manifold, which may connect the pipe arrangements to the pressure reducing means.

Possibly, in plan, the inlet part is in the form of a spiral, which may extend around an axis, which may be the central axis of the stockpile. Possibly, the lowermost part of the support slopes downwardly towards the central axis.

According to a third aspect of the present invention, there is provided a method of using a dewatering apparatus according to any of the preceding fourteen paragraphs to reduce the moisture content of a stockpile.

Possibly, in an initial condition, the stockpile of material is saturated with water. Possibly water is added to the stockpile to bring the stockpile to the initial, saturated condition. Possibly in the saturated condition, the stockpile has a moisture content of 20% w/w or greater, and may have a moisture content of 25% w/w or greater.

Embodiments of the present invention will now be described, by way of example only, and with reference to the accompanying drawings, in which:—

FIG. 1 is a sectional view from a side of a dewatering apparatus in use;

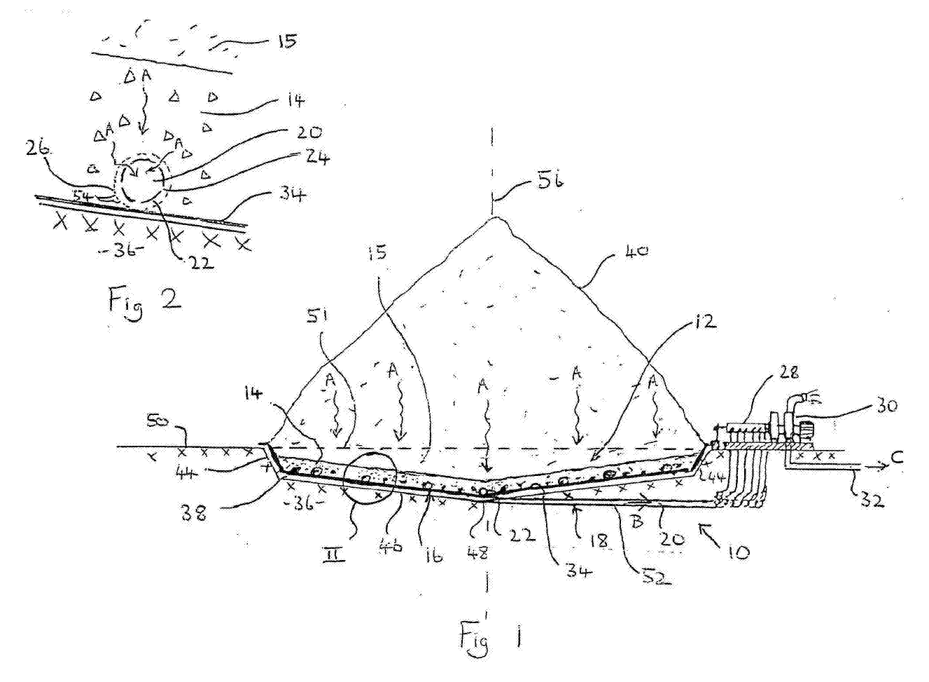

FIG. 2 is an enlarged view of part of the dewatering apparatus indicated by the label II in FIG. 1;

FIG. 3 is a schematic, part sectional side view of part of the dewatering apparatus of FIG. 1;

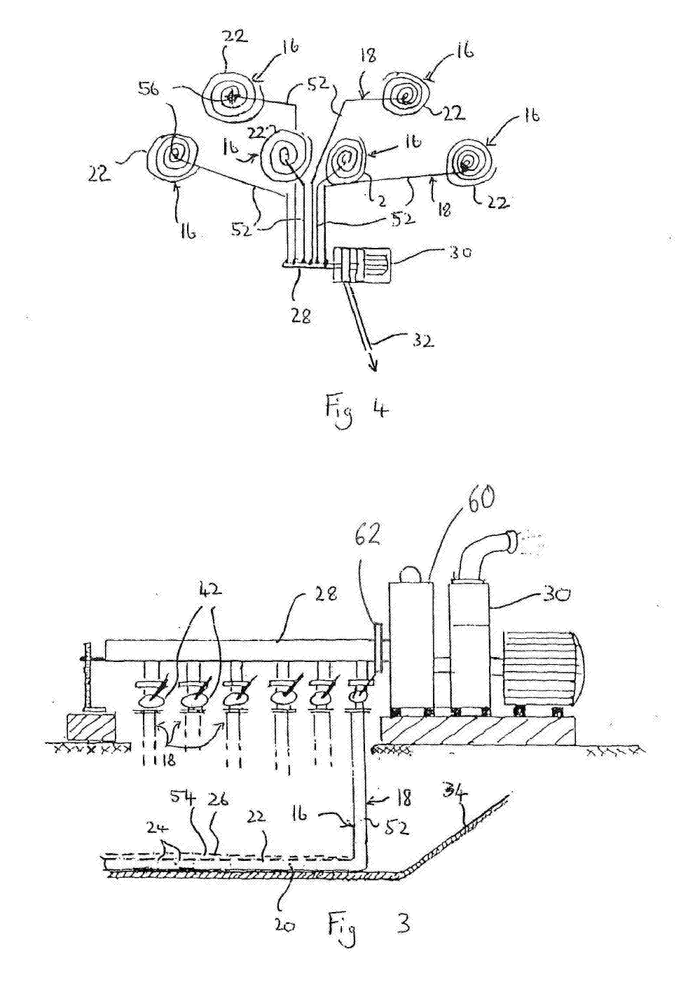

FIG. 4 is a schematic plan view of the dewatering apparatus;

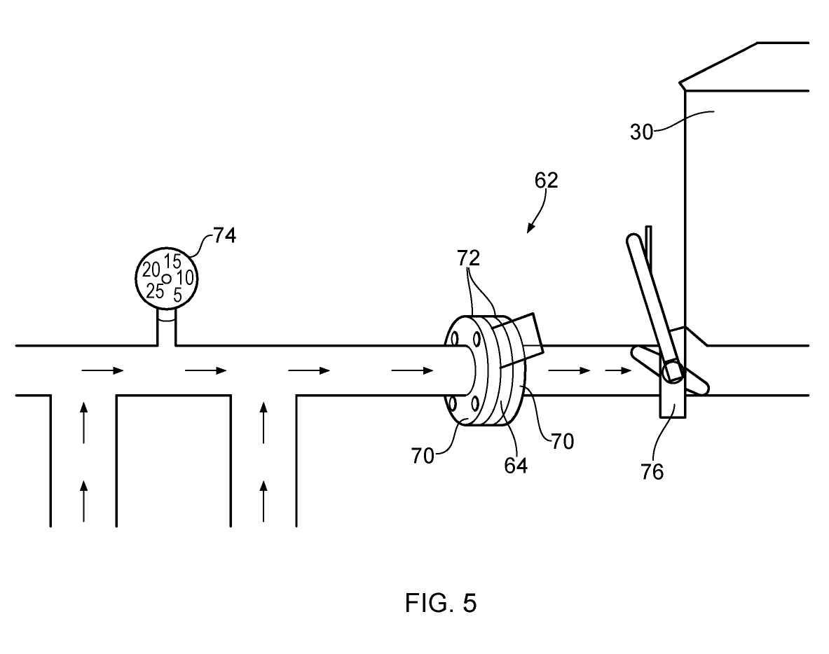

FIG. 5 is a schematic side view of part of a modified apparatus according to the invention;

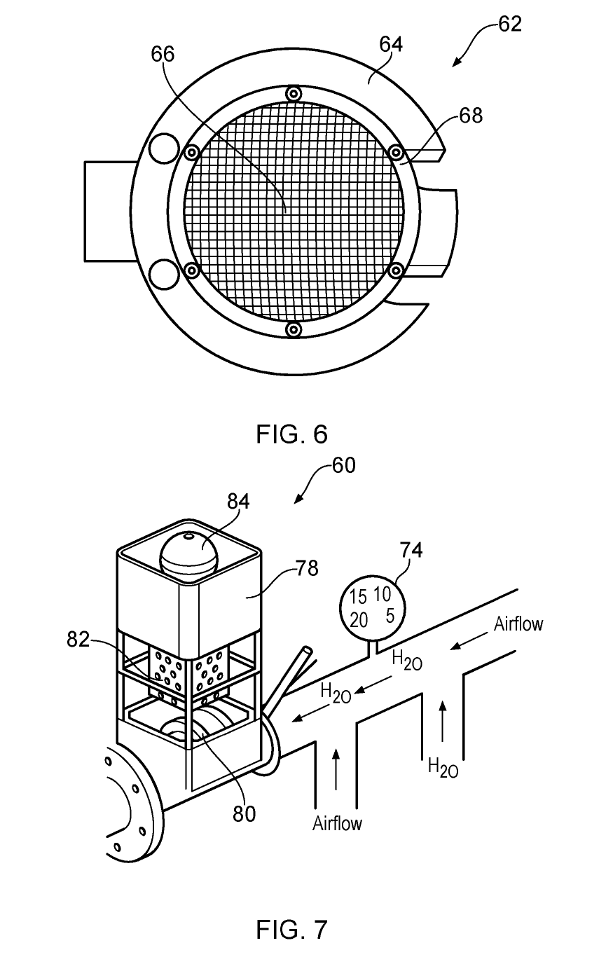

FIG. 6 is a diagrammatic end view through part of the apparatus of FIG. 5; and

FIG. 7 is a schematic perspective view of part of a further modified apparatus according to the invention.

Referring to the figures, FIG. 1 shows a dewatering apparatus 10 which includes a support 12. The support 12 is formed within a recess 38 defined by ground material 36. The recess 38 includes relatively steeply sloping sides 44 and a relatively gradually downwardly sloping base 46, the recess in one example being substantially circular in plan, the sloping base 46 sloping down to a substantially central low point 48.

The support 12 includes a first, lower layer 14 which is formed of a relatively high permeability material. The relatively high permeability material could, in one example, be a gravel.

The support 12 includes a second, upper layer 15 of material, which extends between the lower layer 14 and a level which is coplanar with ground level 50, indicated in FIG. 1 by dotted line 51. The uppermost part of the support 12 is thus substantially at ground level 50.

The dewatering apparatus 10 includes a layer of an impermeable material 34 which is located between the ground material 36 and the support 12. The impermeable material 34, which in one example could be formed of a plastics material, thus forms a lining between the support 12 and the ground material 36, preventing moisture transfer therebetween.

The dewatering apparatus 10 includes pressure reducing means including a pump 30. The pump 30 could, in one example, be a large air handling, self priming double diaphragm suction pump, which could be electrically driven.

The dewatering apparatus 10 includes fluid communication means for communicating fluid from the support 12 to the pump 30, the fluid communication means including a pipe arrangement 16, the pipe arrangement 16 including a pipe 18 which defines a passage 20. The pipe 18 includes an inlet part 22 which is located within the support 12. In one example, as shown in FIGS. 3 and 4, the inlet part 22 is in the form of a spiral in plan and is located on or near to the impermeable material 34 on the sloping base 46. The spiral could extend around a central axis 56, which could extend through the low point 48.

The pipe 18 includes a connecting part 52, which connects the inlet part 22 to a manifold 28 which is in fluid communication with the pump 30. An outlet pipe 32 extends from the pump 30.

Referring to FIG. 2, the inlet part 22 defines a plurality of inlet apertures 24. A filter material 26 extends around the inlet part 22. The filter material 26 defines a plurality of apertures 54 (only a few of which are labeled in FIG. 2) which are relatively small in comparison with the size of the inlet apertures 24. In one example, the filter material 26 could be in the form of a geotextile material.

As shown in FIG. 3 upstream of the pump 30 an air separator 60 is provided, which is best shown in FIG. 7. Upstream of the air separator 60 a solids filter 62 is provided. The solids filter 62 is shown in more detail in FIGS. 5 and 6, but in FIG. 5 the solids filter 62 is shown downstream of the pump 30 without the inclusion of an air separator 60.

The solids filter 62 is in the form of a disc filter with an annular frame 64 across which a mesh filter member 66 in the form of a disc can be fitted. A fixing ring 68 is provided mountable to the frame 64 to clamp the filter member 66 thereto. As can be seen in FIG. 5 the filter member 66 is mounted between two annular plates 70 with rubber gaskets 72 between the plates 70 and the frame 64, to provide an air tight seal. A vacuum gauge 74 is provided on the manifold 28. A gate valve 76 is provided to selectively close off the pump 30. This form of filter 62 readily permits the filter member 66 to be periodically removed, by dismounting of the fixing ring 68 from the frame 64, and cleaned by removing trapped solids therefrom.

FIG. 7 shows the air separator 60 in more detail, and in this instance a solids filter 62 is not provided. The air separator comprises 60 a tank 78 in which a number of curved baffles 80 are provided in a lower part. The tank 78 extends above the baffles 80 and has a central diffuser 82 in the form of a perforated cylinder. A valve 84 is provided at an upper part of the tank 78 to permit air to be released therethrough.

As fluid generally comprising water and air enters the air separator 60, the baffles 80 remove turbulence from the mixed air and water. The air and water tend to separate with the air moving upwardly in the tank 78 and out through the valve 84. The water having had turbulence removed passes through to the pump.

In use, the dewatering apparatus 10 is formed by forming the recess 38 in the ground material 36. The pump 30, the manifold 28 and the connecting part 52 of the pipe 18 are located in position, the connecting part 52 extending from the manifold 28 to the low point 48 of the recess 38. The layer of impermeable material 34 is laid within the recess 38 to line the recess 38 and the inlet part 22 of the pipe 18 located on the impermeable material 34 and connected to the connecting part 52. The filter material 26 could be wrapped around the inlet part 22 when the inlet part 22 is in situ, or alternatively the filter material 26 could be wrapped around the inlet part 22 before installation.

The lower layer 14 of relatively high permeability material is then laid on the impermeable material 34 on the base 46, over and around the inlet part 22. The upper layer 15 is then laid over the lower layer 14.

A stockpile 40 of material is then formed on the support 12. The central axis of stockpile 40 could be coincident with the central axis 56 of the spiral. The stockpile material 40 could be a sand or gravel material. The upper layer 15 could be formed of the same material as the stockpile material 40.

In one example, the stockpile material 40 could be a washed material, which has a relatively high moisture content. In use, in position on the support 12, the water in the stockpile material 40 drains by gravity towards the support 12 as shown by arrows A in FIGS. 1 and 2. The support 12 is formed of material having a permeability greater than that of the stockpile material 40. The relatively high permeability material of the lower layer 14 improves the rate of drainage, drawing water out of the stockpile material 40, and the sloping base 46 of the recess 38 directs the water to the inlet part 22 of the pipe 18.

As shown in FIG. 2, the water passes through the inlet apertures 54 of the filter material 26 and the inlet apertures 24 of the inlet part 22 into the passage 20. The pump 30 operates to reduce pressure in the pipe 18, sucking the water along the pipe 18 towards the pump 30 away from the support 12, through the pump 30 to the outlet pipe 32, which could be connected to a storage tank (not shown) or further processing apparatus (not shown).

The positive removal of water from the support 12 has been found in practice to reduce drying times of the stockpile material 40 significantly. For example, in a conventional stockpile employing only gravity drainage, the moisture content at the base of the stockpile after 30 hours was found to have reduced from 25% w/w to 19% w/w. By employing the dewatering apparatus of the present invention, the moisture content at the base of the stockpile was found to have reduced from 25% w/w to less than 5% w/w in less than five hours.

A further benefit of the use of the dewatering apparatus is that the moisture content at different levels in the stockpile is more consistent. In a stockpile drained only by gravity drainage, moisture contents after 30 hours at the base, at 3 m level and at 4.5 m level were found respectively to be 20%, 10% and 5%. In a stockpile employing the dewatering apparatus of the present invention, the moisture content at the same levels after five hours duration were found respectively to be all 5% or less.

The impermeable material 34 increases the efficiency of drying, since it prevents moisture migration from the ground material 36.

It has been found that, in some circumstances, rapid drying is promoted when the stockpile material 40 initially has a higher moisture content. When the stockpile material 40 has a higher moisture content, more of the pores between the particles making up the stockpile are filled, so that when the suction pump 30 operates, there is a syphon effect, which more effectively draws water from the stockpile material 40 into the support 12 through the upper and lower layers 15, 14 respectively of the support 12, into the pipe 18 and to the pump 30. Thus in one example, the efficiency of drying is increased by initially raising the moisture content of the stockpile material 40 to at least 25% w/w by adding water to the stockpile material 40 to bring the stockpile material 40 to a saturated initial condition.

The solids filter prevents solids above a size determined by the mesh of the filter from reaching the pump and causing damage thereto. The air separator means that substantially only liquid reaches the pump providing for greater efficiency in the system.

As indicated the system may include a solids filter and air separator but in some instances it may be possible for either of these to be omitted from the system.

Various other modifications could be made without departing from the scope of the invention. The dewatering apparatus 10 could include a single pipe arrangement 16, or could include a plurality of pipe arrangements 16 extending from a manifold 28 as shown in FIG. 4. In FIG. 4, six pipe arrangements 16 are connected to a manifold 28 extending from a pump 30. Each of the pipe arrangements 16 comprises an inlet part 22 in the form in plan of a spiral, and a connecting part 52. Each of the inlet parts 22 is located in a support 12 beneath a stockpile 40. As shown in FIG. 3, each of the pipe arrangements 16 could include a valve 42 to enable selective operation of each of the pipe arrangements 16 independently of the other pipe arrangements 16.

The fluid communication means could be of any suitable type. The support 12 and the inlet part 22 could be arranged in a different way. For example, the support 12 could be a different shape in plan. In one example, the support 12 could be rectangular in shape having a sloping base 46 sloping from one side to the other, or from two sides into the middle. The inlet part 22 could be arranged in any suitable way. For example, the inlet part 22 could be arranged in the form of a zigzag or concertina or an arrangement comprising a stem and branches.

The design of the dewatering apparatus 10, and in particular the arrangement of the inlet part 22 could depend upon the nature and type of the stockpile material 40, and in particular, the permeability and other hydraulic characteristics such as hydraulic radius and drawdown of the stockpile material 40. These hydraulic characteristics are determined to a large extent by the particle size distribution and particle shape of the stockpile material 40. In designing the dewatering apparatus 10, it is therefore advisable to undertake trials of specific stockpile materials to optimize the design of the dewatering apparatus for each specific stockpile material.

For example, where the stockpile material 40 is relatively free draining (ie has a relatively high permeability), the hydraulic radius and drawdown are relatively large, and a relatively less dense arrangement of the inlet part 22 could be utilized. Where the stockpile material 40 is relatively less free draining (ie has a lower permeability) a denser arrangement of the inlet part 22 could be utilized.

Selection of the filter material 26 could also depend upon the nature and type of the stockpile material 40. The purpose of the filter material 26 is to prevent relatively fine material from entering the passage 20. The fine material could come from the support 12 and/or the stockpile material 40. The filter material 26 could be selected by reference to, for example, a sieve analysis or grading of the material making up the stockpile material 40.

The support 12 could be of any suitable depth. The lower layer 14 could be of any suitable depth. In one example, the lower layer 14 is approximately 0.3 m deep. However, this depth can varied to suit the nature and type of the stockpile material 40. The pipe 18 could be of any suitable diameter, and could be formed of any suitable material and could include any suitable number of inlet apertures 24. The filter material 26 could be formed of any suitable material, and could include any suitable number of inlet apertures 54.

The pressure reducing means could be of any suitable type.

There is thus provided dewatering apparatus, which provides a vacuum beneath a stockpile of material, to promote drainage of water from the stockpile material, reducing the drying time of the stockpile material. Drying times of the stockpile material are significantly reduced, reducing the amount of stockpile storage required and reducing drying costs when the stockpile material is subject to further processing. Water run off from the stockpile onto surrounding ground is reduced and in many cases eliminated, reducing potential environmental problems. The reduced moisture content in the stockpile material reduces the risk of ice formation during the winter. The water which has been drained from the stockpile material 40 has been filtered, and is therefore relatively clean, and can be reused for washing or other purposes. Reducing the moisture content of the stockpile material 40 reduces the risk of the stockpile becoming unstable and slumping, thereby improving safety and permitting the construction of taller stockpiles with a smaller base area, increasing the amount of storage available on site.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Dewatering apparatus for reducing the moisture content of a stockpile of material, the apparatus including a support for supporting, in use, the stockpile, pressure reducing means, and fluid communication means for communicating fluid from the support to the pressure reducing means wherein the apparatus includes a substantially impermeable layer beneath the support, and the support includes a layer of material which has a permeability which is higher than the permeability of the stockpile material, a solids filter being provided in the fluid communication means to remove solid materials from the fluid prior to the fluid reaching the pressure reducing means.

2. Dewatering apparatus according to claim 1, in which the solids filter comprises a mesh material extendable across the fluid communication means.

3. Dewatering apparatus according to claim 2, in which the mesh material is extendable across an annular frame.

4. (canceled)

5. Dewatering apparatus for reducing the moisture content of a stockpile of material, the apparatus including a support for supporting, in use, the stockpile, pressure reducing means, and fluid communication means for communicating fluid from the support to the pressure reducing means wherein the apparatus includes a substantially impermeable layer beneath the support, and the support includes a layer of material which has a permeability which is higher than the permeability of the stockpile material, an air separator being provided in the fluid communication means to remove air from the fluid prior to the fluid reaching the pressure reducing means.

6. Dewatering apparatus according to claim 5, in which the air separator includes a tank into which the fluid flows, with formations in the tank to stop spinning of the fluid.

7. (canceled)

8. Dewatering apparatus according to claim 6, in which an exhaust is provided in an upper part of the tank to enable air to be exhausted therethrough.

9. Dewatering apparatus according to claim 5, in which the apparatus includes a solids filter and an air separator.

10. Dewatering apparatus according to claim 9, in which the air separator is located downstream of the solids filter.

11.-14. (canceled)

15. Dewatering apparatus according to claim 5, in which in use, the support is located in the ground.

16. Dewatering apparatus according to claim 15, in which the impermeable layer is located between the support and adjacent material in the ground.

17. Dewatering apparatus according to claim 5, in which the layer of higher permeable material is located in a lowermost part of the support.

18. Dewatering apparatus according to claim 5, in which the fluid communication means defines a passage.

19. Dewatering apparatus according to claim 18, in which the fluid communication includes a pipe arrangement, which includes a pipe, which defines the passage.

20. Dewatering apparatus according to claim 19, in which the pipe includes an inlet part, in which the pipe defines one or more inlet apertures through which fluid enters the passage in use.

21. (canceled)

22. (canceled)

23. Dewatering apparatus according to claim 20, in which the inlet part is located within the layer of higher permeable material.

24. Dewatering apparatus according to claim 20, in which the lowermost part of the support is arranged to direct fluid to the inlet part.

25. Dewatering apparatus according to claim 24, in which the lowermost part of the support slopes downwardly towards the inlet part.

26. (canceled)

27. (canceled)

28. Dewatering apparatus according to claim 20, in which the pipe arrangement includes an outer filter, which is arranged to permit entry of the fluid into the passage, but prevent entry of the support and/or stockpile material into the passage.

29-31. (canceled)

32. Dewatering apparatus according to claim 20, in which in plan, the inlet part is in the form of a spiral, which extends around an axis, which is the central axis of the stockpile.

33.-35. (canceled)

36. A method of reducing the moisture content of a stockpile, the method comprising using a dewatering apparatus, the apparatus including a support for supporting, in use, the stockpile, pressure reducing means, and fluid communication means for communicating fluid from the support to the pressure reducing means wherein the apparatus includes a substantially impermeable layer beneath the support, and the support includes a layer of material which has a permeability which is higher than the permeability of the stockpile material, a solids filter being provided in the fluid communication means to remove solid materials from the fluid prior to the fluid reaching the pressure reducing means.

37.-40. (canceled)
